(19) United States
(12) Patent Application Publication
(10) Pub. No.: US 2025/0231118 A1
(43) Pub. Date: Jul. 17, 2025

(54) Apparatus and method for treating plastics preforms

(71) Applicant: KRONES AG, Neutraubling (DE)

(72) Inventor: Florian GELTINGER, Donaustauf (DE)

(21) Appl. No.: 19/021,881

(22) Filed: Jan. 15, 2025

(30) Foreign Application Priority Data
Jan. 15, 2024 (DE) 10 2024 101 047.9

(51) Int. Cl. G01N 21/88; B29B 11/08; B29L 31/00; B65G 47/46; G01N 21/95

(52) U.S. Cl. CPC G01N 21/8851; B29B 11/08; B65G 47/46; G01N 21/95; B29L 2031/712; B65G 2201/0244

(57) ABSTRACT

A production device for producing plastics preforms has a transport device configured for transporting the produced plastics preforms along a predetermined transport path, and a first inspection device configured for inspecting a first portion of the plastics preforms. The inspection device has at least one image recording device configured for recording a spatially resolved image of at least said first portion of the plastics preforms and a second inspection device configured for inspecting a second portion of the plastics preforms. The second inspection device has a second image recording device which is configured for recording a spatially resolved image of at least the second portion of the plastics preforms.

### BACKGROUND OF THE INVENTION

The present invention relates to an apparatus and to a method for treating and/or inspecting plastics preforms. Such plastics preforms are used in the prior art to be formed into plastics containers and in particular plastics bottles. For this purpose, heated plastics preforms are expanded by a blow molding machine. Such plastics preforms are usually injection molded parts that are molded in an injection molding machine. It is known in the prior art that these plastics preforms are inspected before they are supplied to the blowing process.

WO 2018/036 857 discloses a method for optically inspecting hollow bodies, wherein the hollow bodies, in particular plastics preforms, are inspected in a relative position to one another that, in comparison with the injection molding process, remains unchanged.

An apparatus for inspecting plastics preforms is also known from WO 2018/051 227. In this document, a transport means is provided which transports the plastics preforms as well as an inspection device which inspects the plastics preforms.

An optical inspection system for plastics preforms is known from WO 2016/020683.

The object of the present invention is improving such inspection of the produced plastics preforms.

### SUMMARY OF THE INVENTION

The invention relates to an arrangement for treating plastics preforms, wherein the plastics preforms are suitable and intended to be formed into plastics containers, and wherein said plastics preforms are formed in one piece and have at least one main body and one mouth portion arranged on this main body. Furthermore, this arrangement comprises a production device for producing said plastics preforms and a transport device which is suitable and intended for transporting the produced plastics preforms along a predetermined transport path.

Furthermore, the arrangement comprises a first inspection device which is arranged along the transport path of the plastics preforms and which is suitable and intended for inspecting a first portion of the plastics preforms, wherein said first inspection device has at least one first image recording device which is suitable and intended for recording a spatially resolved image of at least one portion, in particular said first portion, of the plastics preform or plastics preforms.

According to the invention, the arrangement comprises a second inspection device, which is preferably also arranged along the transport path of the plastics preforms (i.e. the transport path along which the transport device transports the plastics preforms) and which is suitable and intended for inspecting a second portion of the plastics preform or plastics preforms, wherein said second inspection device has a second image recording device which is suitable and intended for recording a spatially resolved image of at least one portion, in particular the second portion, of the plastics preform or plastics preforms.

It is therefore proposed that the produced plastics preforms are inspected by a first and a second inspection device, wherein in particular two different portions of the plastics preforms, which are in particular spaced apart from one another, are inspected for this purpose. Preferably, the first portion is a mouth portion of the plastics preforms and the second portion is a bottom portion of the plastics preforms.

Preferably, the first and second inspection devices are arranged one behind the other and in particular directly one behind the other along the transport path and/or in the transport device of the plastics preforms.

Particularly preferably, the first and second inspection devices and in particular the image recording device of the first inspection device and second inspection device and in particular the image recording device of the second inspection device are spaced apart from one another in the transport direction of the plastics preforms by less than 100 cm, preferably less than 80 cm, preferably less than 60 cm, preferably less than 50 cm, preferably less than 40 cm, preferably less than 30 cm and preferably less than 20 cm.

The production device is advantageously an injection molding machine.

In a further advantageous embodiment, the arrangement comprises a cooling device for cooling the produced plastics preforms. It is possible for this arrangement to have a partially or completely enclosed space in which the plastics preforms are arranged, at least at times.

In a further advantageous embodiment, the apparatus comprises a transfer device for transferring plastics preforms or groups of plastics preforms from the production device to the transport device. It is possible for the transport device to be brought close to the production device or this receiving space and for the plastics preforms to then be passed to the transport device.

Furthermore, it would be possible for the transfer device to have, for example, at least one gripper, in particular a vacuum gripper, which transports the plastics preforms to the transport device and/or which inserts the plastics preforms into receiving regions of the transport device. Preferably, this transfer device is configured such that the plastics preforms are moved, at least at times, in their longitudinal direction in order to be transferred to the transport device.

In a preferred embodiment, at least one of the image recording devices and preferably both image recording devices is/are stationary. Preferably, the transport device thus transports the plastics preforms past the image recording device(s).

In a further preferred embodiment, at least one temperature measuring device is provided which is suitable and intended for determining a temperature of plastics preforms. It is possible for this temperature measuring device to determine a temperature for all the plastics preforms, for example an average temperature; however, it would also be possible for said temperature measuring device to be suitable and intended for individually measuring the temperatures of individual plastics preforms, preferably all the individual plastics preforms.

In a further preferred embodiment, the image recording devices are configured as line scan cameras or area scan cameras. Preferably, the image recording devices are suitable and intended for recording an image or images in the visible wavelength range.

In a further advantageous embodiment, at least one image recording device and preferably both image recording devices is/are suitable and intended for recording said images of the plastics preforms during movement of the plastics preforms.

In a further advantageous embodiment, the transport device comprises a holding device for holding the plastics preforms, wherein this holding device is preferably suitable and intended for receiving a plurality of plastics preforms. For example, this holding device can be configured as a tray which is suitable and intended for holding a plurality of plastics preforms, in particular individually.

Preferably, the holding device comprises a receiving surface and in particular a flat receiving surface for receiving the plastics preforms, wherein this receiving surface preferably has a plurality of receiving recesses for receiving the plastics preforms. Preferably, these receiving recesses are spaced apart from one another and said receiving recesses preferably have a distance to one another that is greater than half the diameter of the plastics preforms and preferably greater than the diameter of the plastics preforms. This makes it easier to individually inspect the plastics preforms.

In a further advantageous embodiment, the holding device is suitable and intended for holding at least 4, preferably at least 6, preferably at least 8, preferably at least 10, preferably at least 12, preferably at least 20, preferably at least 25, preferably at least 30 and preferably at least 50 plastics preforms.

In a further embodiment, the holding device is suitable and intended for receiving a maximum of 300, preferably a maximum of 200 and preferably a maximum of 150 plastics preforms.

In a further preferred embodiment, the holding device receives the plastics preforms in such a way that some of these plastics preforms, preferably several of these plastics preforms, preferably all of these plastics preforms, are parallel to one another. Particularly preferably, at least some of the plastics preforms are partially and preferably all of the plastics preforms are arranged in a vertical direction (during transport by the transport device).

In a further advantageous embodiment, the holding device comprises a plurality of receiving openings which are arranged in an array. Particularly preferably, these receiving openings are arranged in two directions, which are particularly preferably perpendicular to one another.

In a further preferred embodiment, the transport device is suitable and intended for transporting the containers in at least two different directions. Preferably, the holding device is arranged on said transport device.

It is thus possible for the transport device to convey the plastics preforms and/or the holding devices in a horizontal direction and preferably also in a vertical direction.

However, particularly preferably, the transport device transports the plastics preforms in a linear direction, at least in portions. Particularly preferably, the transport device is suitable and intended for transporting the plastics preforms in three different directions, wherein two of these three directions are preferably opposite directions.

For example, transport in a vertical direction is possible in order to pick up the plastics preforms and transport in a horizontal direction is possible in order to transport the plastics preforms past the inspection device(s).

Particularly preferably, the holding device is arranged on a transport carriage, which in turn can be raised and lowered. Said directions are particularly preferably perpendicular to one another.

In the further preferred embodiments, the transport device is configured such that the plastics preforms are inspected during a movement, preferably during a movement in precisely one direction.

Particularly preferably, the transport device has at least one drive device and preferably at least two drive devices. Preferably, one of these drive devices is suitable and intended for causing the holding device to perform a stroke in the vertical direction. Preferably, one of these drive devices is suitable and intended for effecting the transportation of the plastics preforms in a horizontal direction.

Particularly preferably, these drive devices are selected from a group of drive devices which comprise hydraulic drives, pneumatic drives and in particular electric motor drives.

Particularly preferably, an electric motor drive device is provided for moving plastics preforms in a horizontal direction. Preferably, an electric motor drive device is provided for moving the plastics preforms in a vertical direction.

Particularly preferably, a stroke height within which the transport device and/or the holding device can be moved is adjustable. In this way, adjustment to different lengths of the plastics preforms is possible.

In a further advantageous embodiment, the arrangement comprises a discharge device which is suitable and intended for discharging individual plastics preforms, in particular on the basis of a result of the inspection in particular by at least one inspection device, and in particular the inspection by the first inspection device and/or the second inspection device.

Discharging is understood to mean that individual plastics preforms are discharged and/or disposed of from a normal production process. These plastics preforms are therefore not further processed.

In a further preferred embodiment, the arrangement comprises a control device which outputs at least one control signal which causes an individual plastics preform or a group of plastics preforms to be discharged.

For example, it is possible for individual plastics preforms or a proportion of the plastics preforms to be removed from the transport device using vacuum grippers, for example. Conversely, it would also be possible for plastics preforms that were evaluated intact to be removed and sent for further processing.

In general, intact plastics preforms, i.e., plastics preforms which have been considered intact by both inspection devices, are preferably sent for further processing. Damaged plastics preforms, on the other hand, are preferably discharged.

However, it is also possible for plastics preforms to be individually discarded or further processed.

As mentioned above, it is possible for the discharge device to have a gripping device which is suitable and intended for gripping individual plastics preforms. It would also be conceivable for the holding device and/or the transport device itself/themselves to be configured so as to be suitable for releasing and/or discharging individual plastics preforms. For example, the receiving openings in the holding device of the transport device could have a variable cross section so that individual plastics preforms can be made to fall through the holding devices.

The holding device can also be configured in such a way that it is suitable for letting all the plastics preforms drop. Damaged plastics preforms could be removed before this process, for example using vacuum grippers or other grippers.

Preferably, the transport device is suitable for transporting the holding device in a first direction and in particular in a horizontal direction between a first position in which plastics preforms can be passed to the transport device and a second direction in which plastics preforms can be released from the transport device.

Particularly preferably, the transport device is suitable and intended for moving the plastics preforms that are in the first position in a second direction, in particular a vertical direction (i.e., in particular to raise and/or lower them).

Particularly preferably, the transport device is suitable and intended for moving the plastics preforms that are in the second position in a second direction, in particular a vertical direction (i.e., in particular to raise and/or lower them).

The present invention is further directed to an inspection device for inspecting plastics preforms, wherein the plastics preforms are suitable and intended to be formed into plastics containers, and wherein said plastics preforms are formed in one piece and have at least one main body and one mouth portion arranged on this main body. This inspection device further comprises a transport device which is suitable and intended for transporting the plastics preforms that are produced along a predetermined transport path.

Furthermore, the apparatus has a first inspection device which is arranged along the transport path (of the plastics preforms) and which is suitable and intended for inspecting a first portion of the plastics preforms (and in particular a portion of the mouth portion), wherein said first inspection device has at least one image recording device which is suitable and intended for recording a spatially resolved image of at least one portion and preferably of this first portion of the plastics preform or plastics preforms.

According to the invention, the inspection apparatus comprises a second inspection device which is suitable and intended for inspecting a second portion of the plastics preform(s), wherein said second inspection device has a second image recording device which is suitable and intended for recording a spatially resolved image of at least one further portion and in particular the second portion of the plastics preform(s).

In a further preferred embodiment, the first inspection device has at least two, preferably a plurality of, image recording devices, each of which is suitable and intended for recording at least one image of at least one, and in particular of the first, portion of the plastics preforms transported by the transport device.

In a further preferred embodiment, an image recording device of the first inspection device is assigned to exactly one image recording device of the second inspection device such that these two image recording devices each inspect the same plastics preform or inspect all the plastics preforms that are transported by the transport device in a specific transport lane.

In a further preferred embodiment, the second inspection device has a plurality of image recording devices, each of which is suitable and intended for recording at least one image of a portion and in particular the second portion of the plastics preforms transported by the transport device.

Particularly preferably, the first inspection device has at least 2, preferably at least 4, preferably at least 6 and particularly preferably at least 8 image recording devices.

Particularly preferably, the second inspection device comprises at least 2, preferably at least 4, preferably at least 6 and particularly preferably at least 8 image recording devices.

Preferably, each image recording device of the first inspection device and/or the second inspection device is assigned to at least one, preferably exactly one, of the plastics preforms transported by the transport device.

In a further advantageous embodiment, these image recording devices are arranged in a row. Particularly preferably, this row extends perpendicularly to the transport path of the plastics preforms.

In a further preferred embodiment, the first and/or the second inspection device has/have at most 50, preferably at most 40, preferably at most 30 and preferably at most 20 image recording devices.

Particularly preferably, the at least one image recording device of the first inspection device is arranged above the transport path of the plastics preforms.

In a further preferred embodiment, the at least one image recording device of the second inspection device is arranged above the transport path of the plastics preforms.

Particularly preferably, both the first and second inspection of the plastics preforms takes place from above or in the direction of the mouth of the plastics preforms.

In a further preferred embodiment, at least one inspection device has a lighting device for illuminating the plastics preforms transported by the transport device. Particularly preferably, both inspection devices each have at least one lighting device and in particular a plurality of lighting devices for illuminating the plastics preforms.

Particularly preferably, a plurality of lighting devices are provided, wherein each lighting device is particularly preferably assigned to an image recording device and/or a specific plastics preform transported by the transport device.

Particularly preferably, at least one lighting device and preferably several lighting devices each have flashbulbs. It is possible that these lighting devices are synchronized and/or triggered by the image recording devices.

In a further preferred embodiment, the position of at least one lighting device of the first inspection device and/or the second inspection device is adjustable, in particular in the vertical direction. In this way, adjustment to different lengths of plastics preforms can be achieved. Preferably, the position of all the lighting devices of the first inspection devices and/or all the lighting devices of the second inspection device are adjustable, in particular in the vertical direction.

In a further preferred embodiment, the apparatus has a position detecting device which detects a position of the plastics preforms and/or the holding device which holds the plastics preforms. For example, light barriers can be provided to detect this position. However, it would also be possible to detect this position from a drive of the transport device, for example a servo motor drive.

In a further preferred embodiment, the inspection apparatus comprises a control device which controls at least one image recording device and particularly preferably several image recording devices and preferably all image recording devices of the first inspection device on the basis of a position detected (in particular by the position detecting device) of the plastics preforms to be inspected.

In a further preferred embodiment, the inspection apparatus comprises a control device which controls at least one image recording device and particularly preferably several image recording devices and preferably all image recording devices of the second inspection device on the basis of a position detected (in particular by the position detecting device) of the plastics preforms to be inspected.

In a further preferred embodiment, a lighting device, preferably a plurality of lighting devices and preferably all the lighting devices is/are stationary. Preferably, at least one of the image recording devices (of the first and/or the second inspection device) is stationary. Particularly preferably, several image recording devices are stationary.

In a further advantageous embodiment, at least one lighting device assigned to the first inspection device is arranged above the transport path of the plastics preforms and at least one lighting device assigned to the second inspection device is arranged below the transport path of the plastics preforms.

Particularly preferably, the first inspection device is suitable and intended for inspecting the mouth region of the plastics preforms. Particularly preferably, the second inspection device is suitable and intended for inspecting a bottom region of the plastics preforms.

The first inspection device is particularly preferably suitable and intended for inspecting the plastics preforms using the incident light method. Particularly preferably, the second inspection device is suitable and intended for inspecting the plastics preforms using a direct-light method.

Particularly preferably, the apparatus comprises a control device for activating the first and/or the second lighting device. Particularly preferably, this control device is configured such that the first and second lighting devices illuminate the plastics preforms with a time delay.

Preferably, the apparatus comprises a first comparison device which compares images recorded by an image recording device of the first inspection device with reference images.

Particularly preferably, the apparatus comprises a first image recording device which uses classic, rule-based industrial image processing methods to evaluate the images.

Particularly preferably, the apparatus comprises a first image recording apparatus which uses artificial intelligence (AI) and in particular deep learning on the basis of neural networks (convolutional neural networks, CNNs) to evaluate the images.

Particularly preferably, the apparatus comprises a second comparison device which compares images recorded by an image recording device of the second inspection device with reference images.

This comparison can preferably be used to determine whether each plastics preform has been correctly produced.

In a further advantageous embodiment, the inspection apparatus has a control device which allows different image recording devices of the first inspection device and/or the second inspection device to be activated with a time delay.

This can ensure that recording an image or illuminating of one plastics preform does not affect the recording of an image of another plastics preform.

Preferably, the first image recording devices, which are arranged substantially transversely to the transport direction, are triggered with a time offset of more than 50 μs.

The present invention is further directed to a method for treating plastics preforms, wherein the plastics preforms are suitable and intended to be formed into plastics containers, and wherein said plastics preforms are formed in one piece and have at least one main body and one mouth portion arranged on this main body.

A production device produces these plastics preforms, and a transport device transports the plastics preforms produced along a predetermined transport path.

Furthermore, a first inspection device, which is arranged along the transport path of the plastics preforms, inspects a first portion of the plastics preforms, wherein this first inspection device has at least one image recording device which records a spatially resolved image of at least one portion, and in particular of the first portion, of the plastics preform(s).

According to the invention, a second inspection device inspects a second portion of the plastics preforms, wherein this second inspection device has a second image recording device which records (at least) one spatially resolved image of at least one further portion, and preferably of this second portion, of the plastics preforms.

Preferably, the first portion of the plastics preforms is the mouth portion or a region of the mouth portion. Particularly preferably, the second portion is a portion of the main body of the plastics preforms and in particular a bottom portion.

In particular, the second portion of the plastics preforms is a portion that contains the so-called injection point of the plastics preforms.

In a preferred method, said portions of the plastics preform are spaced apart from one another and in particular arranged at the ends of the plastics preform. In a further advantageous embodiment, the transport device transports the plastics preforms in at least two different directions.

In a further preferred method, the transport device transports the plastics preforms in such a way that they are spaced apart from one another during transport.

In a further preferred method, the transport device transports the plastics preforms at least at times at a transport speed between 0.1 and 10.0 m/s, preferably between 0.25 and 2.5 m/s and particularly preferably between 0.5 and 1.5 m/s.

In a further preferred method, the plastics preforms are transported in parallel to one another.

In a further preferred method, the plastics preforms are transported in a regular and in particular identical orientation. In particular, this is a vertical arrangement or a vertical orientation. This means that the longitudinal direction of the transported plastics preforms preferably runs in the vertical direction.

The present invention is further directed to a method for inspecting plastics preforms, wherein the plastics preforms are suitable and intended to be formed into plastics containers and wherein said plastics preforms are formed in one piece and have at least one main body and one mouth portion arranged on said main body, wherein a transport device transports the produced plastics preforms along a predetermined transport path, and a first inspection device which is arranged along the transport path inspects a first portion of the plastics preforms and wherein said first inspection device has at least one image recording device which records a spatially resolved image of at least one portion, and preferably of the first portion, of the plastics preforms.

According to the invention, the arrangement has a second inspection device which inspects a second portion of the plastics preforms, this second inspection device has a second image recording device which records a spatially resolved image of at least one further portion, and in particular of the second portion, of the plastics preform(s).

In a further preferred method, the plastics preforms are illuminated for inspection, in particular illuminated from at least two different directions.

Preferably, the plastics preforms are at least illuminated from above, in particular from above in the longitudinal direction. In a further preferred method, the plastics preforms are also illuminated from below, in particular from below in their longitudinal direction.

Preferably, incident light inspection is used to inspect the plastics preforms. Transmitted light inspection is particularly preferred for inspecting the plastics preforms.

Particularly preferably, an image is taken during the inspection by the first inspection device in a longitudinal direction of the plastics preforms or slightly obliquely thereto.

In a further preferred method, an image is taken by the second inspection device in the longitudinal direction of the plastics preforms.

In a further preferred method, a proportion of the inspected plastics preforms is forwarded for further processing, in particular forwarded to a sorting device and in particular forwarded to a roller sorting device. Preferably, a proportion of the plastics preforms is discharged. This applies in particular to plastics preforms which have been identified as defective.

### BRIEF DESCRIPTION OF THE DRAWING

Further advantages and embodiments emerge from the accompanying drawing. In the drawing:

FIG. 1 shows a schematic view of an apparatus according to the invention.

### DETAILED DESCRIPTION OF THE INVENTION

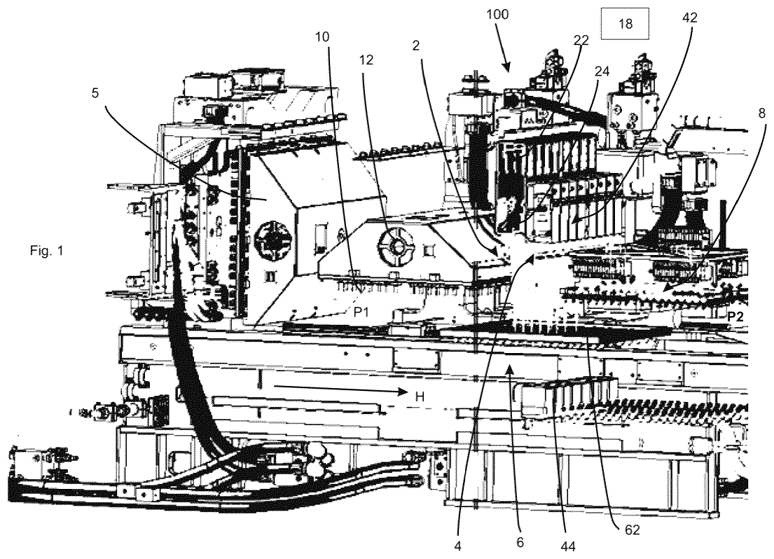

FIG. 1 shows an arrangement according to the invention for treating plastics preforms 10. In this case, reference numeral 5 relates to a production device, in particular, but not exclusively, an injection molding machine for example, which produces plastics preforms 10.

After their production, the produced plastics preforms 10 are transported through a post-cooling and/or handling unit 12 where they are preferably also cooled.

Reference numeral 6 designates a transport device in its entirety for transporting the plastics preforms. This transport device 6 comprises a holding device 62 which is suitable and intended for receiving and/or holding a plurality of plastics preforms.

The holding device is preferably movable in the horizontal direction H between two positions P1 and P2.

In addition, the holding device 62 is also movable in the vertical direction when in the horizontal position P1. In this way, the holding device 62 can be raised and brought to the receiving space 12 where it receives a plurality of plastics preforms 10. For this purpose, the holding device preferably comprises a plurality of recesses for receiving the plastics preforms.

It would be possible to provide gripping devices which pass the individual plastics preforms to the holding device.

The holding device can be transferred from position P1 to position P2. In position P2, plastics preforms can be output or even discharged to a further transport device.

Preferably, this further transport device (not shown) is a transport device that transports the plastics preforms in a disorganized fashion.

Reference numeral 8 designates (roughly schematically) a discharge device which is suitable and intended for discharging individual plastics preforms and in particular plastics preforms 10 which are evaluated as defective.

Reference numeral 100 designates an inspection apparatus in its entirety, which is used to inspect the plastics preforms transported by the transport device 6.

This inspection apparatus 100 further comprises a second inspection device, designated as a whole by 4, which is suitable and intended for inspecting second portions of the plastics preforms. This second inspection device has at least one, and preferably a plurality of, image recording devices 42 such as cameras, which are aligned such that they record spatially resolved images of the plastics preforms 10 transported by the transport device 6.

These second image recording devices are preferably arranged such that they are assigned to the respective transport lanes in which the plastics preforms are transported.

Preferably, each image recording device records an image of each plastics preform transported in exactly one transport lane. However, it would also be possible for each image recording device to record images of several plastics preforms transported in different lanes.

Reference numeral 44 designates a (second) lighting device, which is also a component of the second inspection device 4. This lighting device 44 is arranged below the transport path of the plastics preforms 10 here. Preferably, this lighting device 44 is suitable and intended for illuminating the second portions of the plastics preforms, which are in particular bottom portions.

The above-mentioned control device 18 preferably also controls the image recording devices 42 and in particular the recording of an image by the recording devices recording images. Preferably, said control device also controls the lighting device(s) 44.

Particularly preferably, the recordings of the images of the plastics preforms are also controlled by the control device on the basis of a position of the plastics preforms along the transport path.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, a person skilled in the art will recognize that advantages can also result from a combination of several features shown in individual or in different figures.

1. An arrangement for treating plastics preforms, wherein the plastics preforms are configured to be formed into plastics containers and wherein said plastics preforms are formed in one piece and have at least one main body and a mouth portion arranged on said main body, said arrangement comprising a production device for producing said plastics preforms, a transport device which is configured for transporting the produced plastics preforms along a predetermined transport path, a first inspection device which is arranged along the transport path and is configured for inspecting a first portion of the plastics preforms, and wherein said first inspection device comprises at least one image recording device which is configured for recording a spatially resolved image of at least said first portion of the plastics preforms,
wherein
the arrangement comprises a second inspection device which is configured for inspecting a second portion of the plastics preforms, wherein said second inspection device comprises a second image recording device which is configured for recording a spatially resolved image of at least the second portion of the plastics preforms.

2. The arrangement according to claim 1,
wherein
the transport device has a holding device for holding the plastics preforms, wherein this holding device is configured for receiving a plurality of plastics preforms.

3. The arrangement according to claim 1,
wherein
the transport device is configured for transporting the containers in at least two different directions.

4. The arrangement according to claim 1,
wherein
the arrangement has a discharge device which is configured for discharging individual plastics preforms on the basis of a result of the inspection by the first inspection device or the second inspection device.

5. An inspection apparatus for inspecting plastics preforms, wherein the plastics preforms are configured to be formed into plastics containers and wherein said plastics preforms are formed in one piece and have at least one main body and one mouth portion arranged on said main body, said inspection device comprising a transport device which is configured for transporting the produced plastics preforms along a predetermined transport path, a first inspection device which is arranged along the transport path and is configured for inspecting a first portion of the plastics preforms, and wherein said first inspection device comprises at least one first image recording device which is configured for recording a spatially resolved image of at least the first portion of the plastics preforms,
wherein
the inspection apparatus comprises a second inspection device which is configured for inspecting a second portion of the plastics preforms, wherein said second inspection device comprises a second image recording device which is configured for recording a spatially resolved image of at least the second portion of the plastics preforms.

6. The inspection apparatus according to claim 5,
wherein
the first inspection device has a plurality of image recording devices, each of which is configured for recording at least one image of at least one portion of the plastics preforms transported by the transport device and/or the second inspection device has a plurality of image recording devices, each of which is configured for recording at least one image of at least one portion of the plastics preforms transported by the transport device.

7. The inspection apparatus according to claim 5,
wherein
the at least one first image recording device of the first inspection device is arranged above the transport path of the plastics preforms and/or the at least one second image recording device of the second inspection device is arranged above the transport path of the plastics preforms.

8. The inspection apparatus according to claim 5,
wherein
at least the first or the second inspection device has a lighting device for illuminating the plastics preforms transported by the transport device.

9. The inspection apparatus according to claim 8,
wherein
at least one lighting device assigned to the first inspection device is arranged above the transport path of the plastics preforms and at least one lighting device assigned to the second inspection device is arranged below the transport path of the plastics preforms.

10. The inspection apparatus according to claim 5,
wherein
the inspection apparatus has a control device which is configured to activate different image recording devices of the first inspection device with a time delay and/or the inspection apparatus comprises a control device which is configured to activate different image recording devices of the second inspection device with a time delay.

11. A method for treating plastics preforms, wherein the plastics preforms are configured to be formed into plastics containers and wherein said plastics preforms are formed in one piece and have at least one main body and one mouth portion arranged on said main body, wherein a production device produces said plastics preforms, wherein a transport device transports the produced plastics preforms along a predetermined transport path, and wherein a first inspection device which is arranged along the transport path inspects a first portion of the plastics preforms, wherein said first inspection device has at least one image recording device which records a spatially resolved image of at least one portion of the plastics preforms,
wherein
a second inspection device inspects a second portion of the plastics preforms, wherein said second inspection device has a second image recording device which records a spatially resolved image of at least one further portion of the plastics preforms.

12. The method according to claim 11,
wherein
the transport device transports the plastics preforms in at least two different directions and/or the transport device transports the plastics preforms at a transport speed between 0.1 and 10.0 m/s.

13. The method according to claim 11,
wherein
the plastics preforms are transported in parallel with one another and/or the plastics preforms are transported in a regular arrangement.

14. A method for inspecting plastics preforms, wherein the plastics preforms are configured to be formed into plastics containers and wherein said plastics preforms are formed in one piece and have at least one main body and one mouth portion arranged on said main body, wherein a transport device transports the plastics preforms that are produced along a predetermined transport path, and a first inspection device which is arranged along the transport path inspects a first portion of the plastics preforms, and wherein said first inspection device has at least one image recording device which records a spatially resolved image of the first portion of the plastics preforms,
wherein
the arrangement comprises a second inspection device that inspects a second portion of the plastics preforms, wherein said second inspection device has a second image recording device which records a spatially resolved image of at least the second portion of the plastics preforms.

15. The method according to claim 14,
wherein
the plastics preforms are illuminated from at least two different directions.
